(19) United States
(12) Patent Application Publication
(10) Pub. No.: US 2005/0201388 A1
(43) Pub. Date: Sep. 15, 2005

(54) Method and apparatus for providing a VPN service according to a packet data protocol in a wireless communication system

(75) Inventors: Dong-Wook Suh, Seongnam-si (KR); Gyu-Il Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/075,746

(22) Filed: Mar. 10, 2005

(30) Foreign Application Priority Data
Mar. 10, 2004 (KR) 2004-16231

(51) Int. Cl. H04L 12/56

(52) U.S. Cl. 370/395.53

(57) ABSTRACT

A method and apparatus for providing a Virtual Private Network (VPN) service to a user equipment (UE) according to the Packet Data Protocol (PDP) type of call are provided. In the VPN service providing method, a Gateway GPRS Support Nodes (GGSN) receives a create PDP connection request message from a Serving GPRS Support Nodes (SGSN), for the VPN service of the UE, initializes a Point-to-Point Protocol (PPP) session if the call is an IP call, creates a layer 2 tunneling protocol (L2TP) tunnel with a layer 2 tunneling protocol (L2TP) network server (LNS), sets up a session, sets up a PPP connection with the LNS, and transmits a create PDP context response message to the service node, after the PPP connection.

### PRIORITY

This application claims priority under 35 U.S.C. § 119(a) to an application entitled “Method And Apparatus For Providing VPN Service According To Packet Data Protocol In A Wireless Communication System” filed in the Korean Intellectual Property Office on Mar. 10, 2004 and assigned Serial No. 2004-16231, the entire contents of which are incorporated herein by reference.

### BACKGROUND OF THE INVENTION

1. Field of the Invention

The present invention relates generally to packet data service in a Wideband Code Division Multiple Access (WCDMA) system. In particular, the present invention relates to a method of providing a Virtual Private Network (VPN) service for a Packet Data Protocol (PDP) type Internet Protocol (IP) call.

2. Description of the Related Art

Mobile communication systems refer to a system that services voice or data over a wireless network. Mobile communication systems can be categorized according to multiple access schemes. One of the multiple access schemes is Code Division Multiple Access (CDMA). The CDMA mobile communication system provides mobile communication services using CDMA. It has evolved from the conventional standards focusing on voice transmission/reception to IMT-2000 standards for additional transmission of high-speed data. The IMT-2000 standards relate to services such as high-quality voice, moving pictures, and Internet browsing.

Many techniques have been proposed to service information including voice and data in mobile communication systems. The major examples are a circuit-switched network and a packet-switched network. The circuit-switched network processes circuit data including voice, whereas the packet-switched network processes packet data.

A network needs to be configured to efficiently transmit voice and data in mobile communication systems. This demand is more pressing to mobile communication systems (such as IMT-2000) facing an increasing amount of data use arising from the provisioning of various services. To satisfy the demand, Universal Mobile Telecommunications System (UMTS) was developed from the existing circuit switching-based Global System for Mobile communication (GSM) network. Users use packet data service in the UMTS system to access existing basic Internet applications such as wireless file transmission from a personal computer (PC), e-mail transmission/reception, and Internet browsing over WWW (World Wide Web).

The UMTS system is divided into a radio access portion, and a core network (CN) portion. The radio access portion comprises Node Bs and Radio Network Controllers (RNCs), and the CN portion comprises Serving GPRS Support Nodes) and Gateway GPRS Support Nodes (GGSNs). A mobile subscriber receives data from a data server of an external network over the UMTS network. The external network can be a VPN.

FIG. 1 illustrates protocol stacks for providing a VPN service over a conventional WCDMA network.

Referring to FIG. 1, the WCDMA system comprises a user equipment (UE) 100 that requests the VPN service, a SGSN 110, a GGSN 120, a Layer 2 Tunneling Protocol (L2TP) network server (LNS) 130, and a VPN server 140.

To provide the VPN service to the UE 100, a PDP connection must be activated between the VPN server 140 and the UE 100. By the activated PDP connection, the VPN service is provided from the VPN server 140 to the UE. The nodes 110, 120 and 130 are involved in the provisioning of the VPN service. Specifically, packet data stored in the VPN server 140 is delivered to the UE 100 via the LNS 130, the GGSN 120, and the SGSN 110. Tunnels and sessions for L2TP tunneling must be established between the SGSN 110 and the GGSN 120 and between the GGSN 120 and the LNS 130.

The tunnels are a GTP tunnel between the SGSN 110 and the GGSN 120 and an L2TP tunnel between the GGSN 120 and the LNS 130.

When the UE 100 requests the VPN service, the SGSN 110 establishes the GTP tunnel and a session of protocol stacks is established between the SGSN 110 and the GGSN 120 through the GTP tunnel.

Upon receipt of a Line Control Protocol (LCP) message from the SGSN 110, the GGSN 120 establishes the L2TP tunnel with the LNS 130. The resulting setup of a session of protocol stacks between the GGSN 120 and the LNS 130 through the L2TP tunnel leads to an L2TP connection. As illustrated in FIG. 1, the SGSN protocol stack includes Point-to-Point Protocol (PPP), GTP, User Datagram Protocol (UDP) and IP, whereas the GGSN protocol stack has GTP, UDP and IP. The SGSN 110 is connected to the GGSN 120 by GTP, UDP and IP and the GGSN 120 is connected to the LNS 130 by L2TP, UDP and IP.

The UE 100 exchanges Challenge Handshake Authentication Protocol (CHAP) messages, Password Authentication Protocol (PAP) messages, or Internet Protocol Control Protocol (IPCP) messages with the LNS 130 through the L2TP tunnel. Thus, the UE 100 receives an IP from the VPN server 140 to thereby receive the VPN service.

FIG. 2 is a diagram illustrating a signal flow for establishing a PPP session between the UE 100 and the LNS 130 in a conventional mobile communication system. An operation for establishing a packet data path to provide the VPN service between the UE 100 and the GGSN 110 will be described with reference to FIG. 2.

In FIG. 2, the UE 100 transmits an Activate PDP Context Request (APCQ) message to the SGSN 110, for connection to the VPN server in step 210. The SGSN 110 generates a tunnel identifier (TID) for identifying a GTP tunnel running to the GGSN 120 for the requested PDP connection. That is, the TID identifies the GTP tunnel through which the SGSN 110 transmits packets for the VPN service to the GGSN 120.

In step 212, the SGSN 110 transmits the TID to the GGSN 120 by a Create PDP Context Request (CPCQ) message. In packet transmission, the SGSN 110 attaches the TID to the header of packet data to the GGSN 110. The GGSN 120 transmits a Create PDP Context Response (CPCR) message to the SGSN 110 in step 214. The SGSN 110 transmits an Activate PDP Context Accept (APCA) message to the UE 100 in step 216. In step 210 through step 216, a GTP tunnel path has been established between the UE 100 and the GGSN 120 to support the VPN service.

In step 218, LCP negotiations are made between the UE 100 and the GGSN 120. The LCP negotiations involve negotiations on a maximum receive unit and an authentication protocol related to packet data transmission for the UE 100. The GGSN 120 establishes a VPN service path with the LNS 130 in step 220.

After the establishment of the GTP tunnel between the UE 100 and the GGSN 120, a packet data path for the VPN service must be established between the GGSN 120 and the LNS 130. This process will now be described.

The VPN service path establishment involves L2TP tunnel setup and L2TP session setup. In step 220, the L2TP tunnel is established by transmitting a response message from the LNS 130 to the GGSN 120 in response to a tunnel setup request from the GGSN 120. In step 222, the GGSN 120 requests an L2TP session setup to the LNS 130 and the L2TP session is setup by transmitting a response message by the LNS 130. Through the GTP tunnel, the L2TP tunnel, and the L2TP session, packet data is transmitted between the UE 100 and the LNS 130, for the VPN service.

As described above, the conventional LNS establishes a PPP connection and provides a VPN service through a L2TP tunnel. Since the conventional UE is provided with a PPP stack and receives the VPN service by a PPP call, the PPP connection is required between the UE and the LNS. As a result, transmission of PPP headers among the UE, the SGSN and the GGSN results in additional overhead. Headers between the UE and the RNC impose a larger constraint.

Along with the recent development of packet-based service, the setup of an IP call in a UE has been studied in the UMTS system. Accordingly, techniques of providing the VPN service to the UE by the IP call are needed.

### SUMMARY OF THE INVENTION

An object of the present invention is to substantially solve at least the above problems and/or disadvantages and to provide at least the advantages below. Accordingly, an object of the present invention is to provide a method of reducing the constraint of Point-to-Point Protocol (PPP) headers in a packet data service in a Wideband Code Division Multiple Access (WCDMA) system.

Another object of the present invention is to provide a method of providing a Virtual Private Network (VPN) service using a Packet Data Protocol (PDP) type Internet Protocol (IP) call.

The above objects are achieved by providing a method and apparatus for providing a VPN service to a UE according to the PDP type of call.

According to one aspect of the present invention, in a method of providing a VPN service to a UE within a radio access network according to the PDP type of call in a gateway node connected to a Layer 2 Tunneling Protocol (L2TP) network server (LNS) of a VPN, the gateway node receives a create PDP connection request message from the radio access network, for the VPN service, initializes a PPP session if the call is an IP call, creates a L2TP tunnel with the LNS, sets up a session, sets up a PPP connection with the LNS, and transmits a create PDP context response message to the service node, after the PPP connection.

According to another aspect of the present invention, an apparatus for providing a VPN service to a UE comprises a serving support node connected to the user equipment (UE), a gateway node, and a LNS of a VPN connected to the gateway node. The gateway node receives from the serving support node, a request for the VPN service, initializes a PPP session if the call is an IP call, creates a L2TP tunnel with the LNS, sets up a session, sets up a PPP connection with the LNS, and transmits a create PDP context response message to the serving support node, after the PPP connection.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates protocol stacks for a Virtual Private Network (VPN) service in a conventional Wideband Code Division Multiple Access (WCDMA) network;

FIG. 2 is a diagram illustrating a signal flow for setting up a Point-to-Point Protocol (PPP) session to provide the VPN service from a Layer 2 Tunneling Protocol (L2TP) network server (LNS) to a user equipment (UE) in a conventional mobile communication system;

FIG. 3 illustrates protocol stacks for a VPN service in a WCDMA network according to an embodiment of the present invention;

FIG. 4 is a diagram illustrating a signal flow for setting up a PPP session for providing a VPN service for an Internet Protocol (IP) call according to an embodiment of the present invention;

FIG. 5A illustrates the structure of an End User Address (EUA) according to an embodiment of the present invention;

FIG. 5B illustrates the structure of a Protocol Configuration Option (PCO) according to an embodiment of the present invention and

FIG. 6 is a flowchart illustrating an operation for setting up a session for performing L2TP tunneling, and a PPP session in a Gateway GPRS Support Node (GGSN) according to an embodiment of the present invention.

Throughout the drawings, it should be noted that like reference numbers are used to depict the same or similar elements, features and structures.

### DETAILED DESCRIPTION OF AN EXEMPLARY EMBODIMENT

An embodiment of the present invention will now be described with reference to the accompanying drawings. In the following description, well-known functions or constructions are not described in detail for conciseness.

The embodiment of the present invention provides a method of providing a Virtual Private Network (VPN) service for an Internet Protocol (IP) call, upon request for the VPN service from a mobile subscriber.

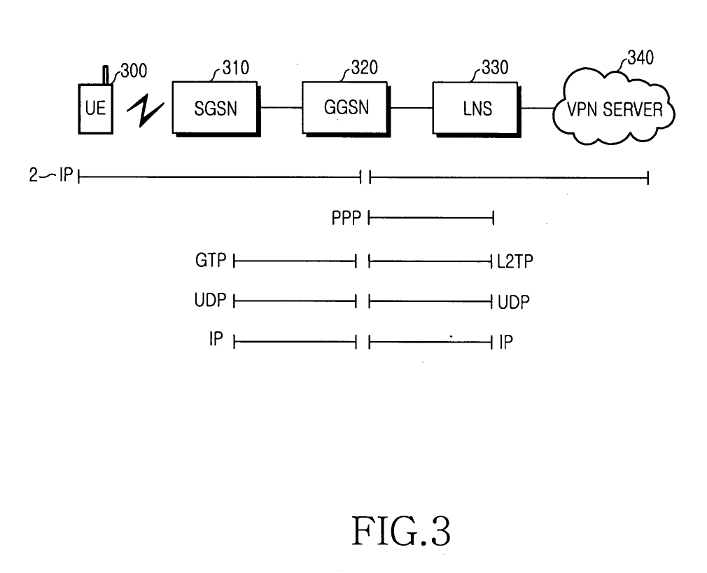

FIG. 3 illustrates protocol stacks for the VPN service in a Wideband Code Division Multiple Access (WCDMA) network according to an embodiment of the present invention.

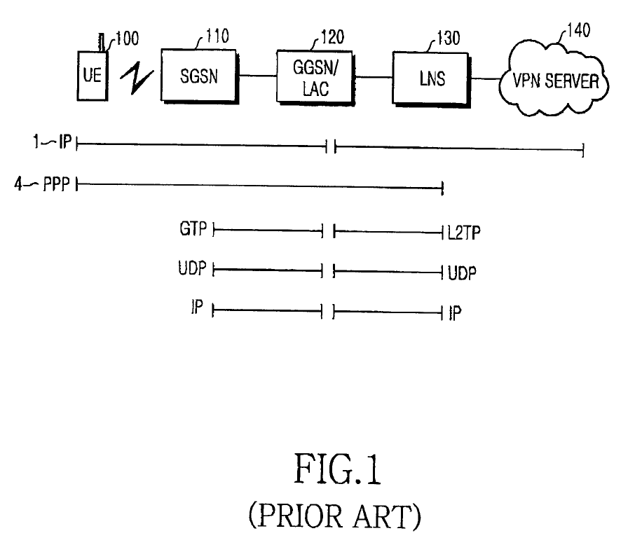

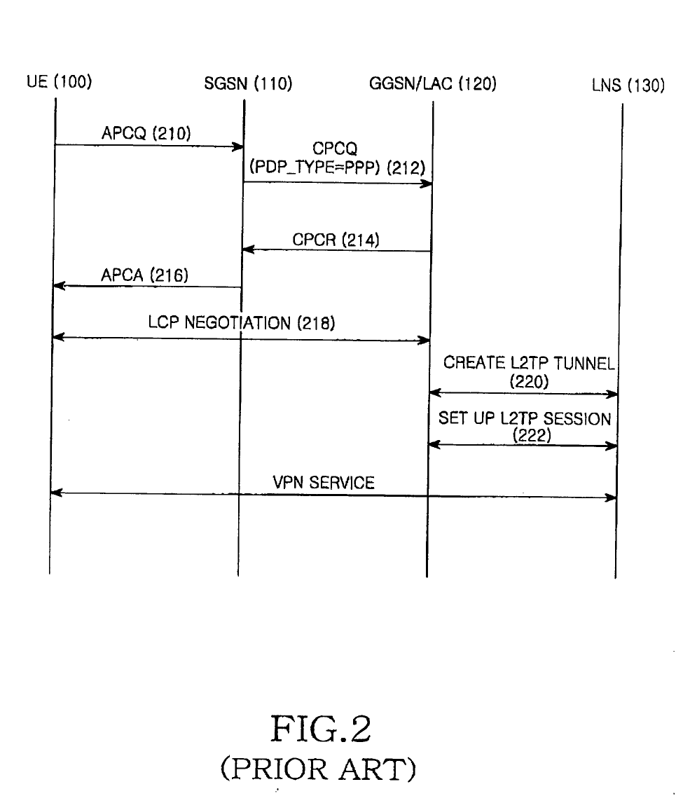

Referring to FIG. 3, the WCDMA system comprises a user equipment (UE) 300 that requests the VPN service, a Serving GPRS Support Node (SGSN) 310, a Gateway GPRS Support Node (GGSN) 320, a Layer 2 Tunneling Protocol (L2TP) network server (LNS) 330, and a VPN server 340. A SGSN protocol stack comprises Point-to-Point Protocol (PPP), GPRS Tunneling Protocol (GTP), User Datagram Protocol (UDP) and IP, and a GGSN protocol stack comprises PPP, L2TP, UDP and IP. While the SGSN 310 is connected to the GGSN 320 by GTP, UDP and IP and the GGSN 320 is connected to the LNS 330 by L2TP, UDP and IP as in FIG. 1, the protocol stacks of FIG. 3 are different from those of FIG. 1 in that a PPP connection exists only between the GGSN 320 and the LNS 330 with no PPP connection between the UE 300 and the GGSN 320. Therefore, the constraint of processing PPP headers is eliminated between the UE 300 and the GGSN 320.

Tunneling between the SGSN and the GGSN and L2TP tunneling between the GGSN and the LNS will be described below in detail.

Referring to FIG. 3, for the VPN service, the UE 300 activates a Packet Data Protocol (PDP) connection with the GGSN 320, for a connection to a desired VPN server 340. With the PDP activation and L2TP tunneling, the VPN server 340 provides the VPN service to the UE 300. The Provisioning of the VPN service involves the nodes 310, 320 and 330. Packet data stored in the VPN server 340 is transmitted to the UE 300 through the LNS 330, the GGSN 320 and the SGSN 310. That is, the VPN service requires a session for L2TP tunneling between the GGSN 320 and the LNS 330.

Specifically, when the UE 300 requests an IP call for the VPN service, the SGSN 310 transmits a Create PDP Context Request (CPCQ) message to the GGSN 320. The GGSN 320 determines based on an Access Point Name (APN) set in the CPCQ message that the PDP type is an IP call, and the call requires VPN service. Then the GGSN 320 initializes a PPP protocol stack and creates a VPN tunnel by exchanging L2TP control messages with the LNS 330. That is, while the SGSN 310 is connected to the GGSN 320 by GTP, UDP and IP and the GGSN 320 is connected to the LNS 330 by L2TP, UDP and IP, a PPP connection exists only between the GGSN 320 and the LNS 330 with no PPP connection between the UE 300 and the GGSN 320.

In the case of an IP call, the UE 300 does not open a PPP session. Instead, the GSSN 320 itself establishes a PPP connection with the LNC 330, thereby creating an L2TP tunnel.

More specifically, since the UE 300 establishes an IP call, it does not need to establish a PPP connection with the LNS 330. Instead, the GGSN 310, having a PPP stack, initializes the PPP session for a PPP connection to the LNS 330. A session of protocol stacks is setup between the GGSN 320 and the LNS 330 through the L2TP tunnel, thereby setting up the L2TP connection. The GGSN 320 makes Line Control Protocol (LCP) negotiations with the UE 300 through the L2TP tunnel and performs a Challenge Handshake Authentication Protocol (CHAP) or Packet Level Procedure (PAP) authentication with the LNS 330 using the ID/Password of the UE 300. In the case where the UE 300 transmits an Activate PDP Context Request (APCQ) message without an IP address, an IP address is allocated from the LNS 330. If the APCQ message has an IP address, the IP address of the UE 300 is used by exchanging Internet Protocol Control Protocol (IPCP) messages.

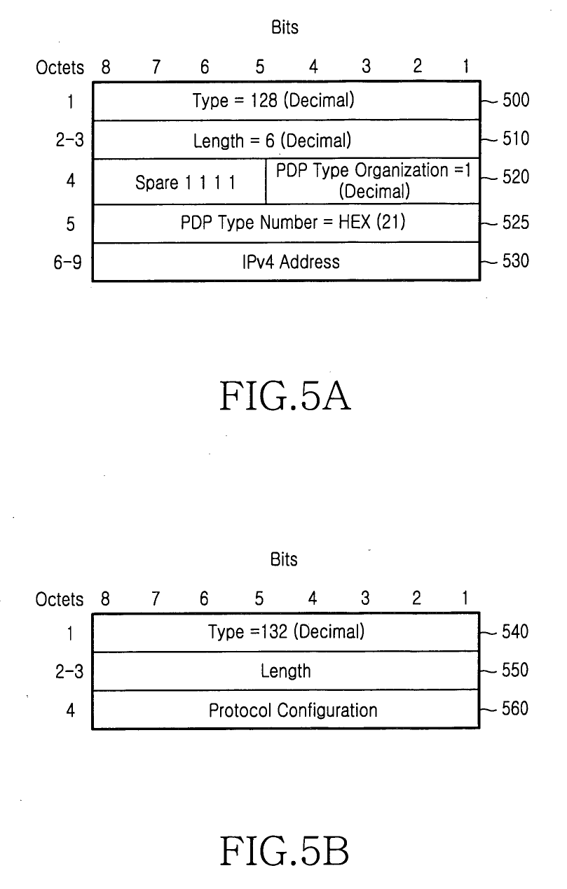

The GGSN 320 performs the authentication procedure based on the presence or absence of the ID/Password of the UE 300. The UE 300 can receive an IP address from the VPN server 340 to receive the VPN service, which will be described later with reference to FIGS. 5A and 5B.

As described above, for the IP call, the GGSN 320 directly sets up the PPP connection so that the L2TP tunnel and session are created between the GGSN 320 and the LNS 330 and thus the UE 300 receives the VPN service.

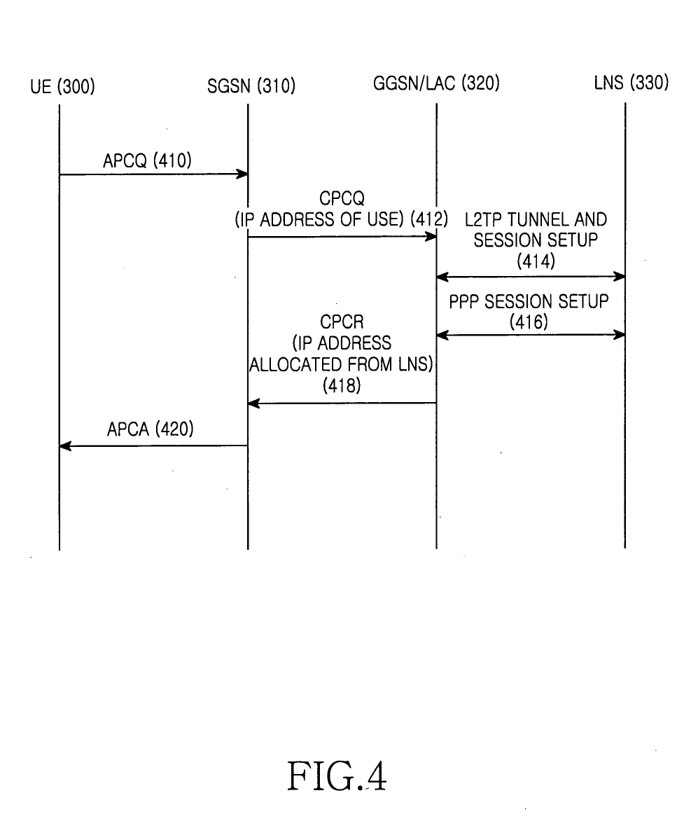

FIG. 4 is a diagram illustrating a signal flow for setting up a PPP session to provide a VPN service for an IP call according to an embodiment of the present invention.

With reference to FIG. 4, setup of a session between the UE 300 and the LNS 330 for an IP call in the WCDMA system will be described below.

In FIG. 4, the UE 300 transmits an Activate PDP Context Request (APCQ) message to the SGSN 310, for connection to the VPN server 340 in step 410. The SGSN 310 transmits a Create PDP Context Request (CPCQ) message to the GGSN 320, for a connection to the VPN server in step 412. The CPCQ message comprises information indicating that the requested call is an IP call or a PPP call, and the IP address of the UE 300 in step 412. Only if the UE has an IP address, does the CPCQ message contain the IP address.

For transmission/reception of packet data requested by the UE 300, a VPN packet data path is established between the GGSN 320 and the LNS 330. This will be described below.

In step 414, the GGSN 320 creates an L2TP tunnel with the LNS 130, for VPN packet data transmission. As illustrated in FIG. 4, the VPN service path establishment involves PPP session initialization, setup of the L2TP tunnel and a session between the GGSN 320 and the LNS 330 in step 414, and PPP session setup in step 416. The setup of the L2TP tunnel and session between the GGSN 320 and the LNS 330 is performed by transmitting a tunnel creation request from the GGSN 320 to the LNS 330 and transmitting a response message from the LNS 330 to the GGSN 320. After the creation of the L2TP tunnel, the GGSN 320 requests setup of an L2TP session to the LNS 330 and the LNS 330 transmits a response message for the L2TP session setup request to the GGSN 320, thereby setting up the L2TP session.

In the case of an IP call, a PPP connection is established between the GGSN 320 and the LNS 330. Specifically, after initializing the PPP session, the GGSN 320 creates the L2TP tunnel and session, and then sets up the PPP session to the LNS 330 in step 416. For the IP call, the GGSN 320 sets up the PPP connection to the LNS 330 by its PPP stack and L2TP stack, beyond its conventional operation of serving the LCP functionality.

In the case where the CPCQ message contains the IP address and ID/Password, the GGSN 320 performs an IPCP authentication with the LNS 330 using the IP address and the ID/Password. On the other hand, in the absence of the ID/Password of the UE 300, a Default ID/Password stored as a setting in the GGSN is used. In the absence of the IP address, the IPCP operation is performed using an IP address for the UE allocated from the VPN server.

In step 418, the GGSN 320 transmits to the SGSN 310 a Create PDP Context Response (CPCR) message including the IP address of the UE 3000 that the LNS 330 has allocated. The SGSN 310 transmits an APCA message to the UE 300 in step 420.

In step 410 through step 420, the tunnels and sessions have been established between the SGSN 310 and the GGSN 320 and between the GGSN 320 and the LNS 330, thereby establishing the VPN service path for the IP call for the UE 300. Then, packet data is transmitted between the UE 300 and the VPN server through the LNS 330 via the GTP tunnel and session between the UE 300 and the SGSN 310 and the L2TP tunnel and session between the GGSN 320 and the LNS 330.

The PDP type and IP address of the UE 300 are included in the End User Addresses (EUAs) of the CPCQ and CPCR messages, and its ID/Password in the PCOs of the CPCQ and CPCR messages. The EUA and PCO will be described in detail with reference to FIGS. 5A and 5B.

FIG. 5A illustrates the structure of the EUA according to an embodiment of the present invention.

The EUA is an element associated with the IP address of the UE 300. The GGSN 320 acquires the IP address of the UE 300 from the EUA received from the SGSN 310. As illustrated in FIG. 5A, the EUA comprises a Type 500, a Length 510, a PDP Type Organization 520, a PDP Type Number 525 identifying PPP or IP as a PDP type, and an IP address 530. The EUA is included in the CPCQ and CPCR messages used for L2TP tunneling between the UE 300 and the LNS 330. Specifically, when a UE having an IP address attempts a call, the SGSN 310 transmits the CQPCQ message including the IP address in the EUA to the GGSN 320.

If the UE does not have an IP address, the IP address is not set in the EUA of the CPCQ message. The GGSN 320 receives an IP address for the UE by exchanging CPCQ and CPCR messages with the LNS 330 and transmits the CPCQ message including the allocated IP address in the EUA to the SGSN 310.

FIG. 5B illustrates the structure of the PCO according to an embodiment of the present invention. Referring to FIG. 5B, the PCO comprises a Type 540, a Length 550, and a Protocol Configuration 560. The PCO has information about a configuration option for each protocol. Specifically, it includes an information element having the ID/Password of a UE. The ID/Password is used for LCP authentication in the GGSN 320.

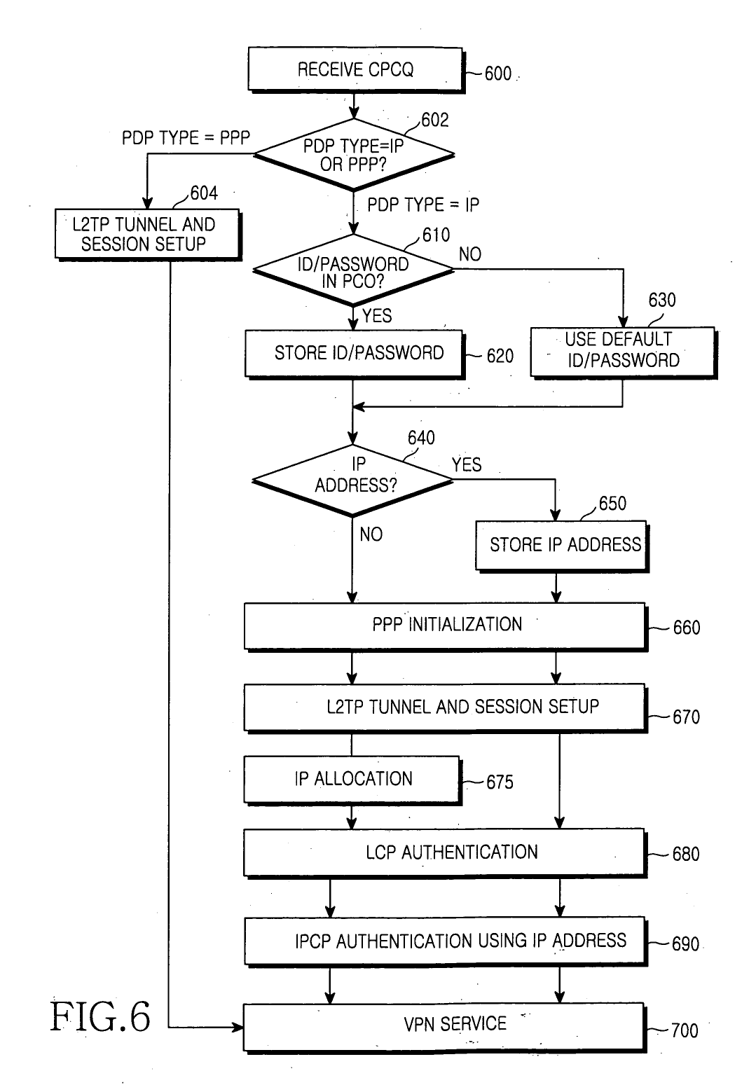

FIG. 6 is a flowchart illustrating an operation for setting up a session for L2TP tunneling and a PPP session in a GGSN according to an embodiment of the present invention.

Referring to FIG. 6, the GGSN receives a CPCQ message requesting a call setup for a VPN service from a UE in step 600. The CPCQ message includes an EUA and a PCO. The GGSN determines from the EUA whether the PDP type of the call is IP or PPP in step 602.

In the case of a PPP call, the GGSN establishes an L2TP tunnel and a session with an LNS in step 604.

In the case of an IP call, the GGSN checks the presence or absence of the ID and Password of the UE in the PCO of the CPCQ message in step 610. Upon detection of the ID and Password, the GGSN stores the ID/Password in step 620 and proceeds to step 640.

In the absence of the ID and Password in the PCO, the GGSN uses a default IP and Password that it has in step 630 and proceeds to step 640.

In step 640, the GGSN checks whether the PCO includes the IP address of the UE.

In the presence of the IP address, the GGSN stores the IP address in step 650 and proceeds to step 660.

In the absence of the IP address, or after storing the IP address, the GGSN initializes a PPP session using a PPP stack that it has in step 660. That is, the GGSN opens a PPP session using information of the CPCQ message and transmits an L2TP control message to an LNS, to open an L2TP tunnel or session.

In step 670, the GGSN sets up the L2TP tunnel and session with the LNS and proceeds to step 680. In the absence of the IP address, the GGSN receives an IP address for the UE from the LNS in step 675 and proceeds to step 680.

The GGSN performs an LCP authentication using the IP and Password to set up the PPP session in step 680 and makes IPCP negotiations using the IP address of the UE in step 690.

If the above operation is completed successfully, the GGSN determines that the PPP connection is completed between the GGSN and the LNS.

In step 700, the GGSN provides VPN service data received from a VPN server to the UE.

In accordance with an embodiment of the present invention as described above, a PPP session is set up between a GGSN and an LNS to provide a VPN service for an IP call. Therefore, overhead caused by transmission of PPP headers between a UE and the GGSN for a PPP call is reduced, thereby preventing unnecessary charges to a network subscriber and also conserving radio resources.

While the invention has been shown and described with reference to a certain embodiments thereof, it should be understood by those skilled in the art that various changes in form and details may be made therein without departing from the spirit and scope of the invention as defined by the appended claims.

1. A method of providing a virtual private network (VPN) service to a user equipment (UE) within a radio access network according to the packet data protocol (PDP) type of call in a gateway node connected to a layer 2 tunneling protocol (L2TP) network server (LNS) of a VPN, comprising the steps of:
receiving a create PDP connection request message from the radio access network for the VPN service;
initializing a point-to-point protocol (PPP) session if the call is an internet protocol (IP) call, creating an L2TP tunnel with the LNS, and setting up a session;
setting up a PPP connection with the LNS; and
transmitting a create PDP context response message to the service node, after the PPP connection.

2. The method of claim 1, wherein the create PDP context request message comprises a first part for the IP address and type of the call and a second part for the identifier (ID)/password of the UE, for the PPP connection.

3. The method of claim 1, wherein the PPP connection setting up step comprises the steps of:
determining whether the create PDP context request message comprises the ID/password of the UE;
storing the ID/password in the presence of the ID/password, and determining to use a pre-stored default ID/password in the absence of the ID/password; and
performing a line control protocol (LCP) authentication using the stored ID/password or the default ID/password.

4. The method of claim 3, wherein the PPP connection setting up step further comprises the steps of:
receiving an IP address from the VPN server through the LNS in the absence of the IP address of the UE in the create PDP context request message; and
providing an internet protocol control protocol (IPCP) negotiation for the UE using the received IP address or the IP address included in the create PDP context request message.

5. The method of claim 4, wherein the create PDP context response message transmitting step comprises the step of transmitting the received IP address to the service node by the create PDP context response message.

6. The method of claim 1, further comprising the step of initializing a PPP protocol stack that the gateway node has before creating the L2TP tunnel.

7. An apparatus for providing a virtual private network (VPN) service to a user equipment (UE) comprising:
a serving support node connected to the UE,
a gateway node; and
a layer 2 tunneling protocol (L2TP) network server (LNS) of a VPN connected to the gateway node, wherein the gateway node initializes a point-to-point protocol (PPP) session if the call is an internet protocol (IP) call, creates a L2TP tunnel with the LNS, sets up a session, sets up a PPP connection with the LNS, and transmits a create PDP context response message to the serving support node, after the PPP connection.

8. The apparatus of claim 7, wherein the create PDP context request message comprises a first part for the IP address and type of the call and a second part for the identifier (ID)/password of the UE, for the PPP connection.

9. The apparatus of claim 7, wherein the gateway node determines whether the create PDP context request message comprises the ID/password of the UE, stores the ID/password in the presence of the ID/password, determines to use a pre-stored default ID/password in the absence of the ID/password, and performs a line control protocol (LCP) authentication using the stored ID/password or the default ID/password.

10. The apparatus of claim 9, wherein the gateway node receives an IP address from the VPN server through the LNS in the absence of the IP address of the UE in the create PDP context request message, and provides an internet protocol control protocol (IPCP) negotiation for the UE using the received IP address or the IP address included in the create PDP context request message.

11. The apparatus of claim 10, wherein the gateway node transmits the received IP address to the service node by the create PDP context response message.

12. The apparatus of claim 7, wherein the gateway node initializes a PPP protocol stack that the gateway node has before creating the L2TP tunnel.
